(19) United States
(12) Patent Application Publication
(10) Pub. No.: US 2010/0234972 A1
(43) Pub. Date: Sep. 16, 2010

(54) METHOD OF THREE-DIMENSIONAL GRAPHICAL MODELLING

(75) Inventors: Marc Pierre Stefano, Livry-gargan (FR); Jerome Mortain, Bois Colombes (FR); Stephane Cadet, Denonville (FR); David Rodriguez, Guyancourt (FR); Jacques Luigi, Paris (FR); Frederic Perron, Montrouge (FR); Bruno Casimir, Nanterre (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/377,742

(22) PCT Filed: Jul. 27, 2007
(86) PCT No.: PCT/FR2007/051740

§ 371 Date: May 20, 2010

(30) Foreign Application Priority Data
Aug. 17, 2006 (FR) 0653388

(51) Int. Cl. G06F 17/50; G06F 19/00

(52) U.S. Cl. 700/98; 700/103

(57) ABSTRACT

The invention relates to the field of methods of three-dimensional graphical modelling. This is a method of three-dimensional graphical modelling of an interface between several elements, comprising at least: for at least two elements, a step of determining one or more parameters of the element that relate to the interface; a step of displaying, at the level of a software resource, a three-dimensional graphical modelling of the interface with the aid of the parameters determined, at least one of the elements being a phase of a manufacturing method, at least one determined parameter of which used for the displaying step corresponds to a constraint imposed by the manufacturing method phase.

The invention relates to the field of three-dimensional graphical modeling methods, and more particularly, three-dimensional graphical modeling methods for an interface, either between two stages of a manufacturing process, or between a mechanical part and a stage of a manufacturing process. Ordinarily, in the field of design, the responsibility for designing a mechanical part falls to a mechanical parts designer, whereas the responsibility for designing a stage of a manufacturing process falls to a designer of manufacturing process stages. This means that various designers are participating in an interface.

According to a prior art, a way is known to create a three-dimensional graphical model of an interface between two mechanical parts and display it on a software resource. However, this prior art has the disadvantage that there is no way to allow for the constraints on the mechanical parts that are related to the stages of the manufacturing process that apply to the mechanical parts.

The invention proposes, in a first embodiment, displaying a three-dimensional graphical model of the interaction between a mechanical part and a stage of a manufacturing process, and, in a second embodiment, displaying a three-dimensional graphical model of the interaction between two stages of a manufacturing process, in a manner similar to the manner according to prior art of displaying a three-dimensional graphical model of the interface between two mechanical parts, by treating a stage of a manufacturing process like a mechanical part, i.e., like an element of an interface. In this way, an interaction a) between two stages of a manufacturing process and b) between a manufacturing stage and a mechanical part can be managed as practically as an interface between two mechanical parts has previously been managed. In addition, advantageously, the ability to incorporate a change proposal, particularly a change proposal from a manufacturing process stage designer to be incorporated by a mechanical part designer or a manufacturing process stage designer, will make it possible to merge to a stabilized interface more quickly than in the past.

In accordance with the invention, a method is provided for three-dimensional graphical modeling of an interface between multiple elements, comprising at least: for at least two elements, a step setting one or more parameters of the element relative to the interface; a step using a software resource to display a three-dimensional graphical model of the interface using the set parameters; characterized in that at least one of the elements is a stage of a manufacturing process for which at least one set parameter used for the display step corresponds to a constraint prescribed by the manufacturing process stage.

Two distinct preferred scenarios are to be considered, the first scenario being the one that takes into account only the interactions between stages of a manufacturing process, the second scenario being the one that also addresses both the interactions between a mechanical part and a manufacturing process stage, and optionally, the interactions between manufacturing process stages and the interfaces between mechanical parts. Also, the second scenario includes complex interactions that can bring one or more stages of a manufacturing process into play with one or more mechanical parts.

In the first scenario, at least two elements are stages of a manufacturing process for which at least one set parameter used for the display step corresponds to a constraint prescribed by the manufacturing process stage, and none of the elements whose set parameter is used for the display step is a mechanical part.

In the second scenario, at least one of the elements is a mechanical part for which at least one set parameter used for the display step is a geometric data unit for the part. Preferably, all of the parameters set for a mechanical part and used for the display step are geometric data for the part.

In both the first and second scenarios, all of the parameters set for a stage of a manufacturing process and used for the display step are preferably constraints prescribed by the manufacturing process stage. In the rest of the text, unless otherwise stated, only the second scenario will be described, but the detailed description/presentation of the invention that follows can also be applied to the first scenario.

To be able to correctly design the interaction between a stage of a manufacturing process and the mechanical part to which this manufacturing stage applies within a reasonable time, it is advantageous to have close coordination between the designer of the manufacturing process stage and the designer of the mechanical part at the interface between the manufacturing process stage and the mechanical part. This is the reason that each time the designer of a manufacturing process stage changes his stage of the manufacturing process where it interfaces with a mechanical part, he must discuss the feasibility of the proposed change with the designer of the mechanical part, usually at the next team meeting, which can entail some waiting time.

During this time, the designer of the mechanical part has no knowledge of the proposed change, and often does not find out about it until the next team meeting. The designer of the manufacturing process stage to be changed could attempt to contact his coworker to explain the change he is proposing, but he may have trouble reaching him or forget to do it.

To remedy this difficulty, in the three-dimensional graphical modeling method, even when the designer of a manufacturing process stage forgets to notify the designer of a mechanical part, or anyone involved in the development of the interface between the manufacturing process stage and the mechanical part, of a proposed change to his manufacturing process stage precisely where it interfaces with the other designer's mechanical part, then, preferably, the other designer or anyone involved can be automatically notified about the proposed change, which will allow him to be informed about it before the next team meeting.

Thus, preferably, the three-dimensional graphical modeling method comprises a step in which an alert is sent to a target software resource under the control of a user about the change being made on another software resource under the control of another user to a stage of the process at the interface, and the step displaying the three-dimensional graphical model of the interface on the target software resource can integrate said change. Advantageously, a three-dimensional graphical model of the interface is displayed with said change integrated when a graphic alert representing the alert information is activated on the target software resource.

This open flow of information enabled by the method of the invention between the members of one design team, which serves to automatically notify the other member or members involved when one member is planning to change his stage of the manufacturing process where it interfaces with at least one mechanical part, can produce a marked improvement in the robustness of the relevant interface over a predetermined project development period, while eliminating, or at the very least, sharply reducing the risk of having to do a last-minute revision of the various parameters of the interface, which can then result in significant cost overruns. The possibility of viewing the state of an interface in real time, particularly the change proposal or proposals being considered by one or more designers of a manufacturing process stage at an interface, and which have not yet been accepted by all those involved in this interface, makes it possible to have interface facilitation, in particular by an interface facilitator, which is quicker and more effective. Moreover, this ability is paired with the ability to exchange information about the interface directly and in real time, insofar as any counterproposal to the change being considered will be reported in the same way to the designer who authored the proposed change.

The graphic alert is any graphic element that can be used as a symbol to alert a user that a change in a stage of a manufacturing process at the relevant interface has been requested by the designer of the manufacturing process stage that needs to be changed. This graphic element can be an element that is added to what is already in place, or a modification thereto or a combination of the two. In a preferred embodiment, the graphic alert is an icon that is added to the existing information. In another embodiment, the graphic element is a change in the formatting of an existing information unit.

Preferably, the graphic alert is displayed in a way that is representative of the manufacturing process stage being changed. That is, it is helpful not only to be alerted about a change proposal, but to be able to see immediately from the placement of the graphic alert which manufacturing process stage of the interface is affected by the proposed change. Advantageously, a graphic alert is displayed in a way that is representative of the software resource used to make the change or the user in control of said software resource. Indeed, on fairly comprehensive or complex projects where more than one designer might work on a manufacturing process stage, it is also helpful to know which of the designers working on the relevant manufacturing process stage is proposing the change to said manufacturing process stage.

The modeling method can be devised so that only certain changes deemed as important enough to have an impact on others who are involved in the interface will be posted, i.e., sent to another user's software resource. However, it is preferable to report any change to the manufacturing process stage at the interface, regardless of its magnitude, in order to avoid diversions. Thus, preferably, any change to a manufacturing process stage at the interface will result in sending at least one alert to a target software resource.

Preferably, at least one change in the manufacturing process stage at the interface, and certainly any change to a part at the interface, will result in sending an alert to a plurality of target software resources. That is, on a concrete project, many participants at the interface can benefit by being advised as soon as possible about a change proposal for a manufacturing process stage at the interface. This includes the designers of the other stages in the manufacturing process, for example, or the designers of the mechanical part or parts to which the manufacturing process stages apply, as long as all these manufacturing process stages and all these mechanical parts are part of the same interface. It could also for example include an interface facilitator in charge of overseeing the development of an interface and making it consistent. Preferably, graphic alerts corresponding to multiple interfaces can be displayed simultaneously. This feature is worthwhile especially for the interface facilitator, but can also be helpful for a designer whose stage in the manufacturing process or whose mechanical part has multiple interfaces with the manufacturing process stage or mechanical part of another designer.

In order to avoid alerting the other participants in an interface in an inconvenient manner, i.e., to avoid sending an alert proposing a change followed by another alert proposing a counter-change whose purpose is either to return to the initial state or to further develop the change proposed since the latest consolidated version, a change proposal will preferably be reported to the other participants only if it seems sufficiently developed and advanced, at least, to its own author. Thus, preferably, the alert is sent as soon as the change is validated by its author.

Preferably, one or more reference graphic elements corresponding respectively to one or more stabilized versions of the interface associated with the graphic alert can be displayed simultaneously with the graphic alert, and activating a reference graphic element will display the three-dimensional graphical model of the corresponding consolidated version of the interface. This way, by enabling direct comparison between the most recent consolidated version and the change proposal, it is easier to estimate the impact of said change. Since this advantageous feature keeps a record of the development of an interface, it also provides a clearer vision of the development of the interface, as well as an easier way to turn around and go back if an impasse is reached. At any time, one can look up the state of the interfaces for every milestone in the design process.

Preferably, the three-dimensional graphical model is accompanied by comments in text. This feature is particularly helpful for changes that are not immediately visible with graphics or that are inadequately visible with graphics; the text comments can provide details, explanations, or even justification by conveying the reason for the change proposal.

Preferably, when a graphic alert is displayed, it is accompanied by a cautionary graphic element when the change in the manufacturing process stage that produced the graphic alert violates one or more programmable rules in the three-dimensional graphical modeling method. This serves to indicate immediately how difficult and/or dangerous the actual implementation of the proposed change is. This way, the interface facilitator can, for example, quickly reject as unacceptable a change proposal that significantly transgresses a mandatory rule, thereby preventing another designer from spending time trying to make adjustments for a change that has no chance of being accepted in the end. This safeguard requiring compliance with—or at least reporting deviations from—minimum rules of the profession at all design stages makes it possible to improve or at least evaluate the robustness of the interface. These rules of the profession, which advantageously are programmable at the user's option, can for example be design rules or manufacturing rules or some combination of the two.

Preferably, the stage or stages of the manufacturing process are stage or stages in a manufacturing process for motor vehicle mechanical parts. Actually, a vehicle design project requires working with a large number of interfaces. For this reason, a tool such as the modeling method according to the invention is particularly beneficial and worthwhile in the automotive field.

Preferably, a graphic alert is displayed with a CATPart or CATProduct file in a program from the CATIA family. Advantageously, this program would be CATIA v5 or a later version.

A large part of the foregoing description was in the context of a change proposal for a manufacturing process stage with impacts on a mechanical part, but it can also be done reciprocally, i.e., for a change proposal for a mechanical part that affects a manufacturing process stage.

Thus, the method similarly and preferably comprises a step in which an alert is sent to a target software resource under the control of a user about the change being made on another software resource under the control of another user to a mechanical part at the interface, and the step displaying the three-dimensional graphical model on the target software resource can integrate said change.

Preferably also, a three-dimensional graphical model of the interface is displayed with said change integrated when a graphic alert representing the alert information is activated on the target software resource. Advantageously, the graphic alert is displayed in a way that is representative of the modified mechanical part. When a graphic alert is displayed, it is advantageously accompanied by a cautionary graphic element when the change in the mechanical part at the source of the graphic alert violates one or more programmable rules in the three-dimensional graphical modeling method.

The invention will now be described in more detail using the annexed figures, which are given as illustrative and non-limiting examples, in which:

FIG. 1 schematically represents an example of a view of a mechanical part assigned to a mechanical parts designer;

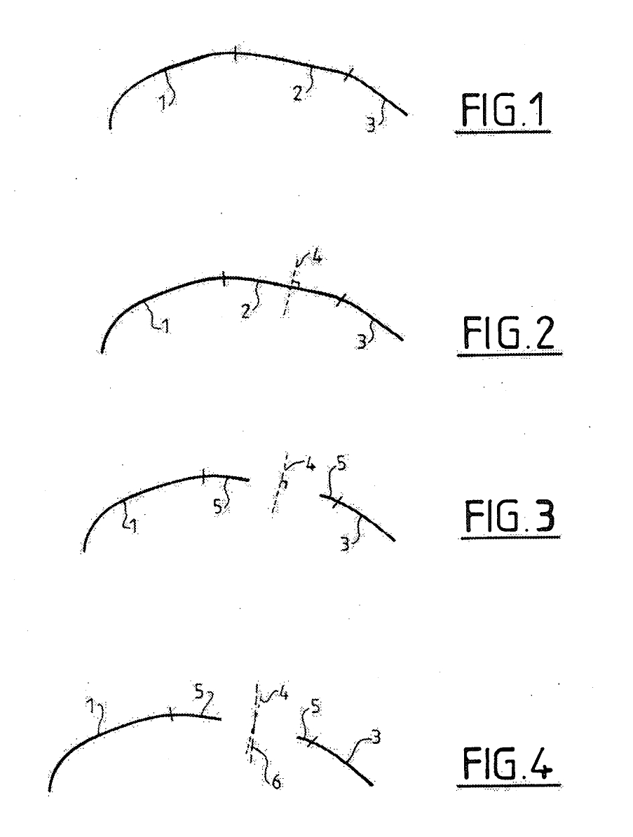

FIG. 2 schematically represents an example of a view of a manufacturing process stage assigned to a manufacturing process stage designer;

FIGS. 3 to 5 schematically represent an example of multiple developments in an interface between a mechanical part assigned to a mechanical part designer and a manufacturing process stage assigned to a manufacturing process stage designer;

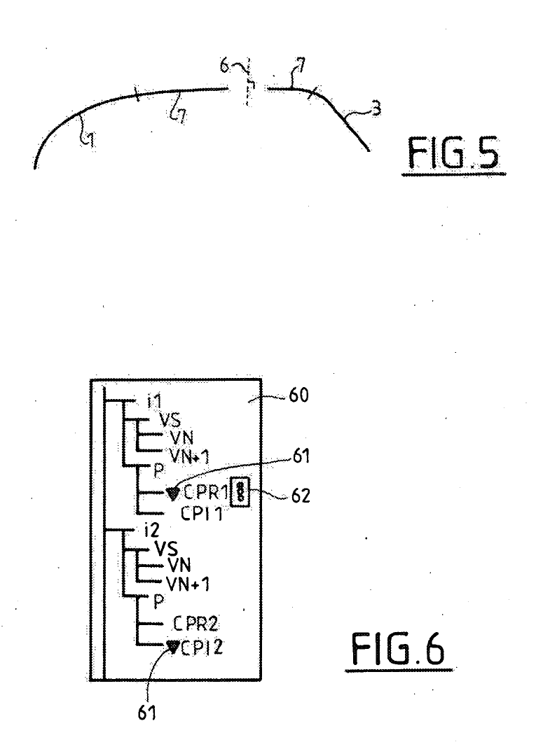

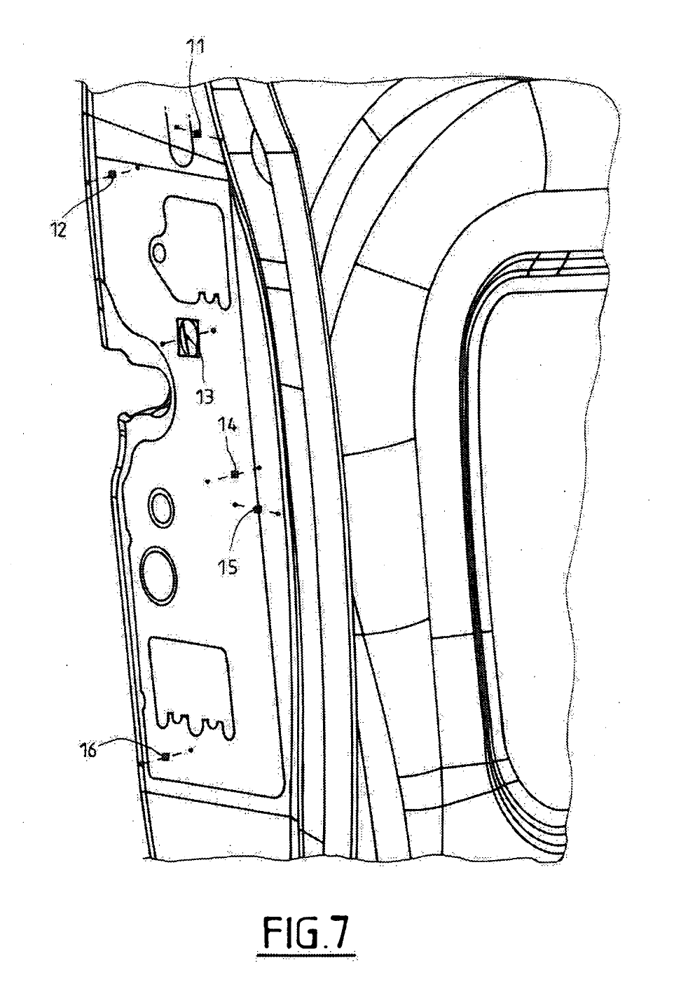

FIG. 6 schematically represents an example displaying a graphic alert according to an advantageous embodiment of the three-dimensional graphical modeling method according to the invention;

FIG. 7 schematically represents a sample view of the display step of the three-dimensional graphical modeling method according to the invention.

The interface at which a mechanical part, on the one hand, and a manufacturing process stage intended for said mechanical part, on the other hand, are located, will comprise both information needed to design the mechanical part itself and information needed to comply with the constraints prescribed by the manufacturing process for said mechanical part.

The constraints prescribed by the manufacturing process for a mechanical part can be of various types. Some non-exhaustive examples are listed here: First of all, there are the rules of the profession that must be followed in order to ensure the very feasibility of the mechanical part, so these are consequently mandatory. Next, there are the rules of the profession that, when followed, serve to reduce costs, whether of investment in equipment or of production of the mechanical part. Lastly, there are rules for assembly that must be followed or else the assembly plant will have to be modified, such as setting aside an area for access by a screw driving machine or complying with a functional volume envelope to be scanned during assembly of the mechanical part. An example of the forming stage of a mechanical part will now be described in conjunction with FIGS. 1 to 5. In order to explain the operations more simply, the views have been drawn in two dimensions, but in reality, the graphical representation is three dimensional.

FIG. 1 schematically represents an example of a view of a mechanical part originating from a mechanical part designer. This mechanical part can be broken down into three main parts: part 1, part 2 and part 3.

FIG. 2 schematically represents an example of a view of a stage of a manufacturing process originating from a manufacturing process stage designer. When forming the part, there is a stamping stage done in a certain stamping direction for feasibility and cost reasons. The direction 4 is shown by a straight line. For feasibility and cost reasons, this direction 4 as shown in FIG. 2 is desirable; for other feasibility and cost reasons, it should also remain perpendicular to the plane of part 2 of the mechanical part to be stamped.

FIGS. 3 to 5 schematically represent an example of development of an interface between a mechanical part assigned to a mechanical part designer and a manufacturing process stage assigned to a manufacturing process stage designer.

FIG. 3 represents the mechanical part/stamping stage interface in a stabilized version 1. Part 2 is divided into two parts 5 by the stamping operation.

FIG. 4 represents a change proposal. During design development, the designer of the stamping stage wants a change in the stamping direction, which he would like to see shifted from direction 4 toward direction 6. This change proposal is what the mechanical part designer will see displayed in three dimensions when he activates a graphic alert visible on his screen. The graphic alert is explained in detail later with FIG. 6. When the designer of the mechanical part sees this change proposal, he realizes that it will require him to adjust parts 5 of the mechanical part, because the mean plane of the sub-parts 5 is no longer perpendicular to the new proposed stamping direction 6.

FIG. 5 once again represents a stabilized version of the interface, e.g., version 2. After being evaluated and discussed within the team, the change proposed by the designer of the stamping stage has been accepted. Consequently, the designer of the mechanical part changed the sub-parts 5, which became the sub-parts 7, whose mean plane is once again perpendicular to the stamping direction 6. The mechanical parts designer could have shared the change in his mechanical part upstream in the process by means of a counter proposal that would also have generated a graphic alert as explained with FIG. 6.

FIG. 6 schematically represents an example displaying a graphic alert in accordance with the three-dimensional graphical modeling method according to the invention;

This graphic alert is shown schematically as part of an example of an interface facilitation space to which change proposals are sent and in which they are displayed. An interface file 60 is manipulated by an interface facilitator, who is in charge of a certain number of interfaces dealing with a set of zones of interaction between mechanical automotive parts and associated manufacturing process stages. The manufacturing process stages may involve forming, fitting, sheet metal work and assembly, for example. The interface facilitator can be a participant outside the design department involved in the interfaces or one of the designers working directly on the interfaces. For the sake of simplicity, in this file 60 only two interfaces i1 and i2 have been shown, but the file 60 can contain many more. The interface facilitator's software resource that contains and displays the file 60 is a target software resource. This file type can also be found in a version that contains generally fewer interfaces or only one interface on the software resource of a manufacturing process stage designer whose manufacturing process stage has one or more interfaces with a mechanical part or with a plurality of mechanical parts. Likewise, this file type can also be found on the software resource of a mechanical parts designer. The file 60 is advantageously structured as follows when it is displayed. The interface i1 comprises two subdirectories: VS and P.

The subdirectory VS includes stabilized versions of the interface, i.e., versions that at some point have been accepted by all of the team members participating in this interface, or that were set by the interface facilitator, or more generally speaking, that were consolidated by a supervisor because all objections had been overcome or all changes incorporated. In FIG. 6, two prior versions are shown: an older version VN and a more recent version VN+1. This record of stabilized versions of the interface makes it possible to monitor the development of the interface over time.

The subdirectory P comprises any existing change proposals originating from various designers. The interface i1 is an interface between a manufacturing process stage and a mechanical part to which said manufacturing stage is to be applied. Consequently, the designer CPR1 of the manufacturing process stage and the designer CPI1 of the mechanical part are the ones who will be able to propose changes to the manufacturing process stage and the mechanical part, respectively. In FIG. 6, only designer CPR1 has proposed a change, which is signaled by the graphic alert 61, here a triangular icon added to the reference CPR1 by being displayed near the reference CPR1; it could be the reference CPR1 itself displayed in another color. No graphic alert is displayed with the reference CPI1, and thus, designer CPI1 has not proposed a change. In addition, the change proposed by designer CPR1 violates a programmable rule, here a manufacturing rule associated with the manufacturing process stage by designer CPR1, which is automatically reported by displaying a cautionary graphic element 62, here a red light.

By activating the graphic alert 61, on the software resource that displays the file 60, a three-dimensional model is displayed of the interface i1 that integrates the change proposed by the designer CPR1 for the associated manufacturing process stage. Thus, by simply activating the graphic element 61, e.g., by clicking or double-clicking on it, immediately the interface i1 facilitator and/or the designer CPI1 of the associated mechanical part can visually take in the proposed change by designer CPR1 to the associated manufacturing process stage, which change may of course necessitate a change to the mechanical part by designer CPI1.

By activating the cautionary graphic element 62, on the target software resource that displays the file 60, the programmable rule that would be violated by the proposed change is displayed, and a note explaining why this change constitutes a violation and/or what the violation is.

The interface i2 comprises the same two subdirectories, VS and P. The subdirectory VS is identical to that of the interface i1. Depending on how far along the design project is, however, it can comprise fewer or more stabilized versions.

The subdirectory P similarly comprises any existing change proposals originating from various designers. The interface i2 is an interface similar to the interface i1. In FIG. 6, only the designer CPI2 of a mechanical part has proposed a change, which is signaled by the graphic alert 61.

No graphic alert is displayed with the reference CPR2, and thus, the designer CPR2 of the manufacturing process stage to be applied to the mechanical part has not proposed a change. Moreover, the change proposed by the designer CPI2 does not violate any programmable rule, which here would be, e.g., a design rule for the mechanical part of the designer CPI2; this can be seen by the absence on the display of a cautionary graphic element 62.

By activating the graphic alert 61, on the software resource that displays the file 60, a three-dimensional model is displayed of the interface i2 that integrates the proposed change to said mechanical part by the mechanical part designer CPI2. Thus, with a simple activation, immediately the facilitator for the interface i2 and/or the designer CPR2 of the manufacturing process stage to be applied to the mechanical part can visually take in the proposed change by the designer CPR2 for the associated mechanical part, which modification can of course result in the need for a modification to the manufacturing process stage of design CPR2.

When a designer proposes a change in his design, whether for a mechanical part or an associated manufacturing process stage, an alert about said change proposal is sent to the interface file. These information flow streams are set up at the beginning of the project and are saved, although it is not impossible to change them during the project. Since the method is devised so that a change to the manufacturing process stage at the interface i1 by the designer CPR1 would cause an alert to be sent to the file 60, for this reason a graphic alert 61 is displayed in the subdirectory P of the interface i1 near the reference CPR1, in the file 60 display space.

Likewise, since the method has been devised so that any change to the mechanical part at the interface i2 by the designer CPI2 would cause an alert to be sent to the file 60, for this reason a graphic alert 61 is displayed in the subdirectory P of the interface i2 near the reference CPI2.

Likewise also, for a change proposal issuing from the designer CPI1 for the interface i1 or from the designer CPR2 for the interface i2, graphic elements 61 would be displayed either in the interface i1 subdirectory P near the reference CPI1 or in the interface i2 subdirectory P near the reference CPR2.

Being thusly advised in advance about a change to a part at an interface makes it possible to view the development of an interface in real time and improves efficiency for the next meeting devoted to the development of this interface, with each participant having been able to automatically learn of changes proposed by the others before said meeting.

The file 60 is preferably a CATProduct file (registered trademark) from CATIA v5 software (registered trademark), but the information can also be supported by a CATPart file (registered trademark).

FIG. 7 schematically represents a sample view of the display step of the three-dimensional graphical modeling method according to the invention. FIG. 7 shows the example of a three-dimensional graphical model of a vehicle door lining with lock reinforcement. Six bearing zones, numbered 11 to 16, are shown with the following notation: for each of the bearing zones, the bearing point corresponds to a small square, whereas the bearing direction is represented with a dotted line connecting two small circles. In this nonlimiting example, each bearing zone 11 to 16 thus represents an interface characterized by a point and a line that must be adhered to by both the designer of the mechanical part—here, the door lining—and the designer of the manufacturing process stage—here, the application of an assembly means.

1. Method for three-dimensional graphical modeling of an interface between multiple elements, comprising at least:
for at least two elements, a step setting one or more parameters of the element relative to the interface;
a step using a software resource to display a three-dimensional graphical model of the interface using the set parameters;
wherein at least one of the elements is a stage of a manufacturing process for which at least one set parameter used for the display step corresponds to a constraint prescribed by the manufacturing process stage.

2. Method according to claim 1, wherein at least two elements are stages of a manufacturing process for which at least one set parameter used for the display step corresponds to a constraint prescribed by the manufacturing process stage, and none of the elements whose set parameter is used for the display step is a mechanical part.

3. Method according to claim 1, wherein at least one of the elements is a mechanical part for which at least one set parameter used for the display step is a geometric data unit for the part.

4. Method according to claim 3, wherein all of the parameters set for a mechanical part and used for the display step are geometric data for the part.

5. Method according to claim 1, wherein all of the parameters set for a stage of a manufacturing process and used for the display step are constraints prescribed by the manufacturing process stage.

6. Method according to claim 1, wherein the method comprises a step of sending an alert to a target software resource under the control of a user about the change being made on another software resource under the control of another user to a stage of the process at the interface, and in that the step displaying the three-dimensional graphical model on the target software resource can integrate said change.

7. Method according to claim 6, wherein a three-dimensional graphical model of the interface is displayed with said change integrated when a graphic alert representing the alert information is activated on the target software resource.

8. Method according to claim 6, wherein the graphic alert is displayed in a way that is representative of the manufacturing process stage being changed.

9. Method according to claim 6, wherein, when a graphic alert is displayed, it is accompanied by a cautionary graphic element when the change in the manufacturing process stage that produced the graphic alert violates one or more programmable rules in the three-dimensional graphical modeling method.

10. Method according to claim 3, wherein the method comprises a step of sending an alert to a target software resource under the control of a user about the change being made on another software resource under the control of another user to a mechanical part at the interface, and the step displaying the three-dimensional graphical model on the target software resource can integrate said change.

11. Method according to claim 10, wherein a three-dimensional graphical model of the interface is displayed with said change integrated when a graphic alert representing the alert information is activated on the target software resource.

12. Method according to claim 10, wherein the graphic alert is displayed in a way that is representative of the modified mechanical part.

13. Method according to claim 10, wherein, when a graphic alert is displayed, it is accompanied by a cautionary graphic element when the change in the mechanical part at the source of the graphic alert violates one or more programmable rules in the three-dimensional graphical modeling method.

14. Method according to claim 1, wherein the alert information is sent as soon as the change is validated by its author.

15. Method according to claim 1, wherein the graphic alerts corresponding to multiple interfaces can be displayed simultaneously.

16. Method according to claim 1, wherein one or more reference graphic elements corresponding respectively to one or more stabilized versions of the interface associated with the graphic alert can be displayed simultaneously with the graphic alert, and activating a reference graphic element will display the three-dimensional graphical model of the corresponding stabilized version of the interface.

17. Method according to claim 1, wherein the stage or stages of the manufacturing process are stages in a manufacturing process for motor vehicle mechanical parts.
